(19) United States
(12) Patent Application Publication
(10) Pub. No.: US 2009/0194998 A1
(43) Pub. Date: Aug. 6, 2009

(54) Electric generator assembly

(75) Inventor: Yu-Liang Lin, Kaohsiung County (TW)

Correspondence Address: DLA PIPER LLP (US ), 2000 UNIVERSITY AVENUE, EAST PALO ALTO, CA, 94303-2248, US

(73) Assignee: YLC Precision Co., Ltd., Kaohsiung County (TW)

(21) Appl. No.: 12/157,798

(22) Filed: Jun. 12, 2008

(30) Foreign Application Priority Data
Feb. 1, 2008 (TW) 097202226

(51) Int. Cl. H02K 57/00

(52) U.S. Cl. 290/1 R

(57) ABSTRACT

An electric generator assembly is used on a vehicle having a frame and a rotating element, and includes a bracket that is adapted to be fixed to the frame of the vehicle, a support, an electric generator, and an adjusting unit. The support is pivotably mounted to the bracket. The electric generator is mounted on the support and includes a roller that is adapted to be engaged with the rotating element of the vehicle so as to be driven thereby. The adjusting unit is employed to adjust relative positioning between the bracket and the support to engage the roller with the rotating element and release the roller from the rotating element.

### CROSS-REFERENCE TO RELATED APPLICATION

This application claims priority of Taiwanese Application No. 097202226, filed on Feb. 1, 2008.

### BACKGROUND OF THE INVENTION

1. Field of the Invention

This invention relates to an electric generator assembly, more particularly to an electric generator assembly for a vehicle that is adjustable so as to remain engaged with a rotating element of the vehicle.

2. Description of the Related Art

As illustrated in FIGS. 1, 2, and 3, a conventional electric generator 12 is installed on a frame 200 of a vehicle. The electric generator 12 has a hollow bracket 111 mounted on the frame 200 of the vehicle, a spring 112 disposed in the bracket 111, a limiting member 113 provided on the bracket 111, and a pivotable connecting member 114 provided on the bracket 111 and connected to the spring 112. The electric generator 12 has a shaft 120, and a roller 121 provided at a distal end of the shaft 120. The roller 121 is selectively placed in contact with a wheel 100 of the vehicle so that the electric generator 12 generates electrical energy when the wheel 100 rotates.

The connecting member 114 can pivot the electric generator 12 between a contact position and a non-contact position. When the electric generator 12 is at the non-contact position as shown in FIG. 2, the roller 121 does not make any contact with the wheel 100. When the limiting member 113 is pulled, due to the biasing force exerted by the spring 112, the connecting member 114 propels the electric generator 12 to move to the contact position, as shown in FIG. 3. When the electric generator 12 is at the contact position, the roller 121 contacts the wheel 100, resulting in rotation of the roller 121 when the wheel 100 rotates such that the electric generator 12 produces electrical energy.

During normal operating conditions, in order to maintain the electric generator 12 at the contact position, the spring 112 must exert a large biasing force so as to prevent the roller 121 from being removed from the wheel 100 while traveling on a rugged road or trail surface.

However, when the spring 112 has such a high degree of stiffness, the roller 121 of the electric generator 12 presses excessively hard against the wheel 100 to thereby create resistance and result in wearing of the wheel 100.

### SUMMARY OF THE INVENTION

The object of the present invention is to provide an electric generator assembly that can overcome the above drawbacks of the prior art.

According to the present invention, an electric generator assembly is used on a vehicle having a frame and a rotating element, and includes a bracket adapted to be fixed to the frame of the vehicle, a support, an electric generator, and an adjusting unit. The support is pivotably mounted to the bracket. The electric generator is mounted on the support and includes a roller that is adapted to be engaged with the rotating element of the vehicle so as to be driven thereby. The adjusting unit is employed to adjust relative positioning between the bracket and the support to engage the roller with the rotating element and release the roller from the rotating element.

### BRIEF DESCRIPTION OF THE DRAWINGS

Other features and advantages of the present invention will become apparent in the following detailed description of the preferred embodiment with reference to the accompanying drawings, of which:

FIG. 1 is a side view of a conventional electric generator;

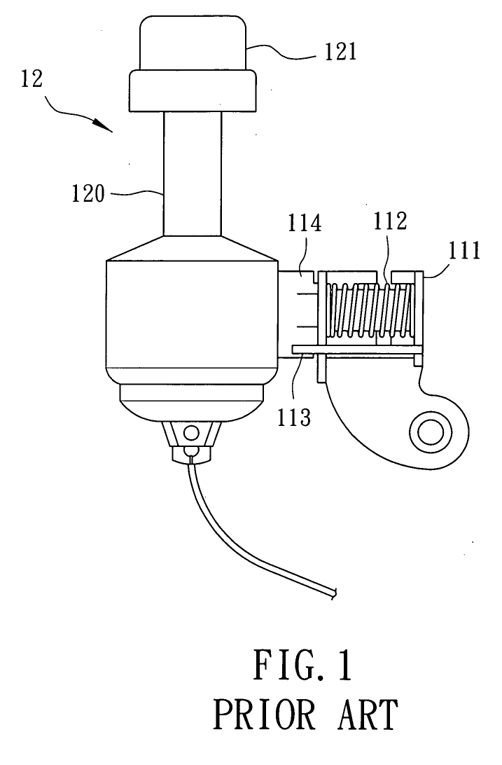

FIG. 2 is a front view of the electric generator shown in FIG. 1, illustrating the electric generator in a state mounted to a vehicle and at a non-contact position;

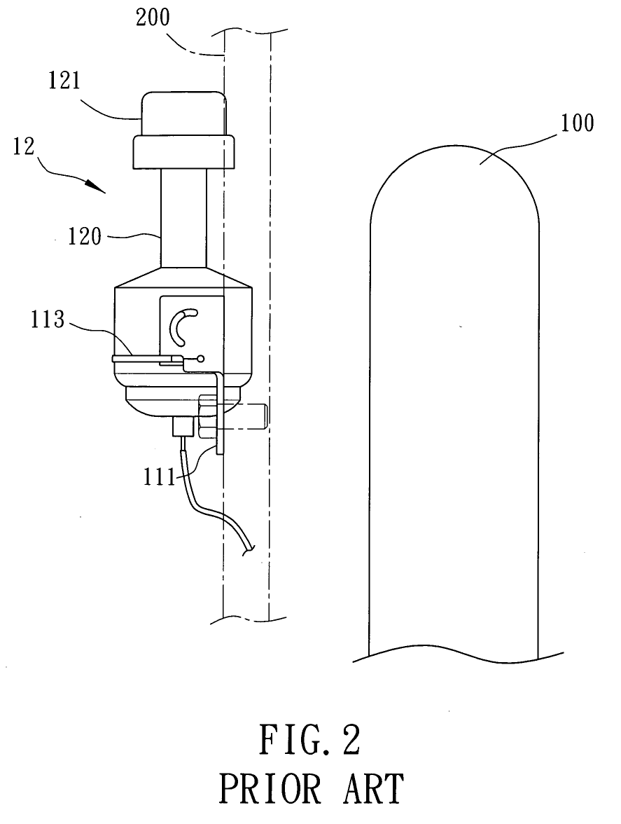

FIG. 3 is another front view of the electric generator shown in FIG. 1, illustrating the electric generator in a state mounted to the vehicle and at a contact position;

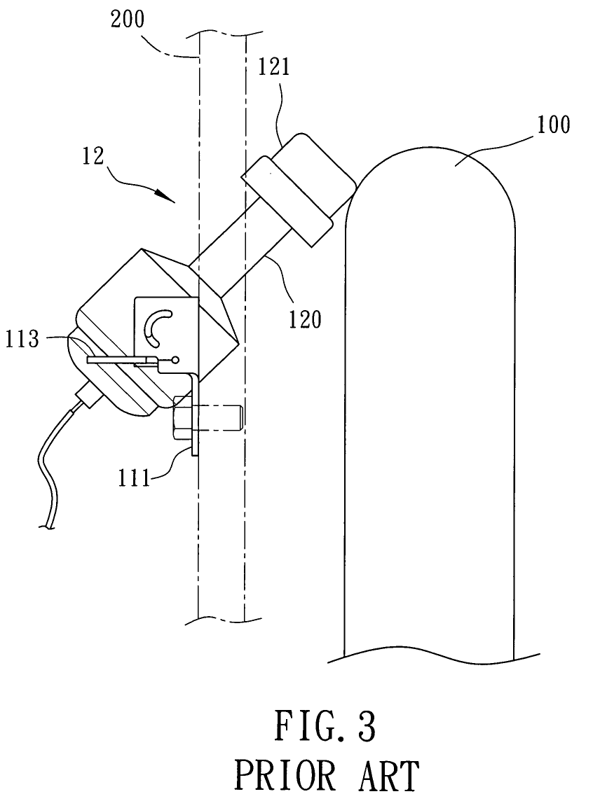

FIG. 4 is a perspective view of the preferred embodiment of an electric generator assembly according to the present invention, illustrating the electric generator assembly in a state assembled on a frame of a vehicle and contacting a wheel of the vehicle;

FIG. 5 is a side view of the electric generator assembly in accordance with the preferred embodiment of the present invention; and

FIG. 6 is another side view of the preferred embodiment, illustrating the electric generator assembly viewed from a side opposite to that in FIG. 5.

### DETAILED DESCRIPTION OF THE PREFERRED EMBODIMENT

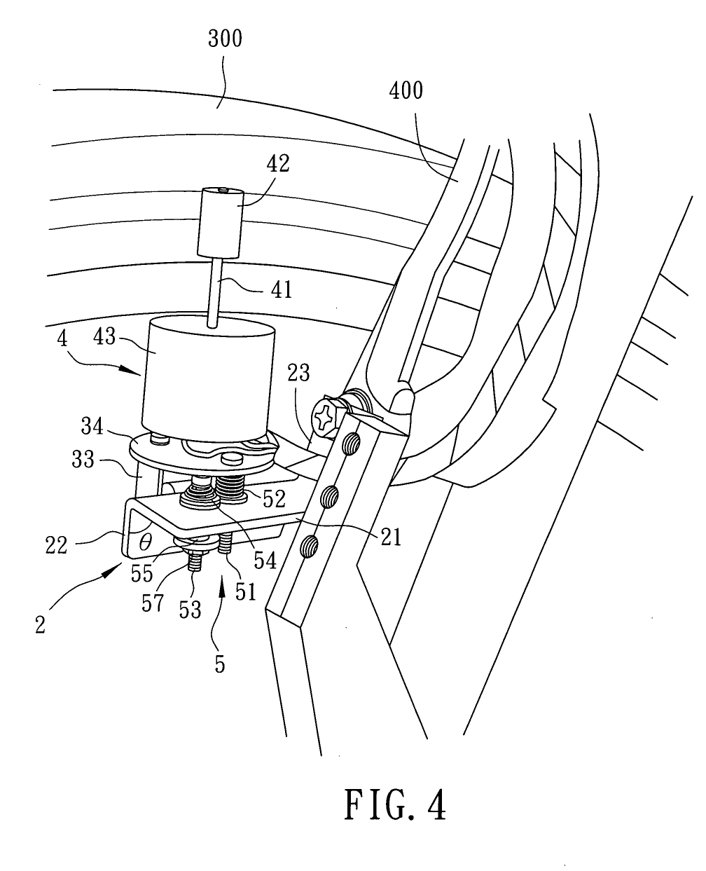

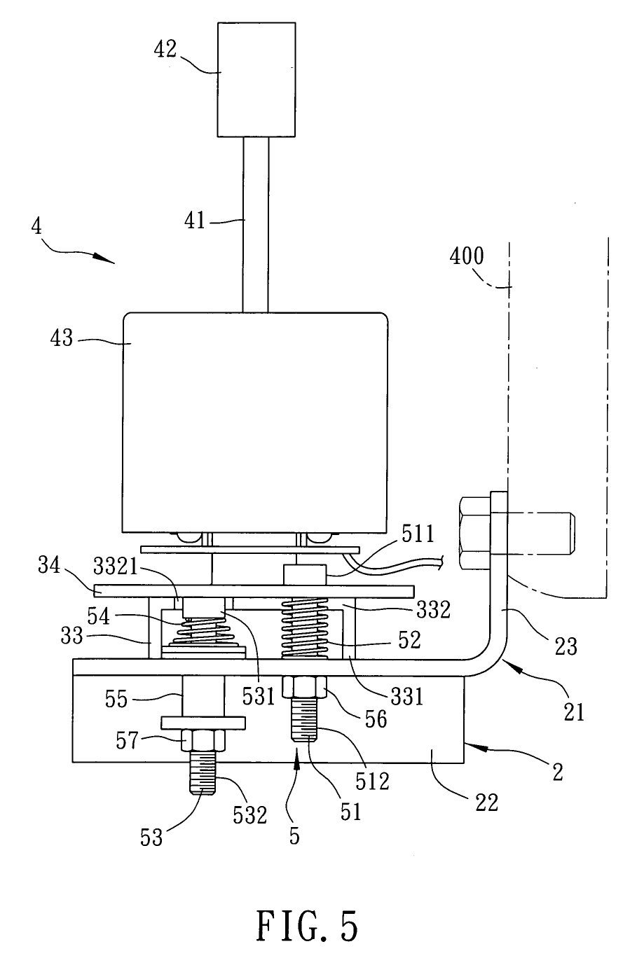

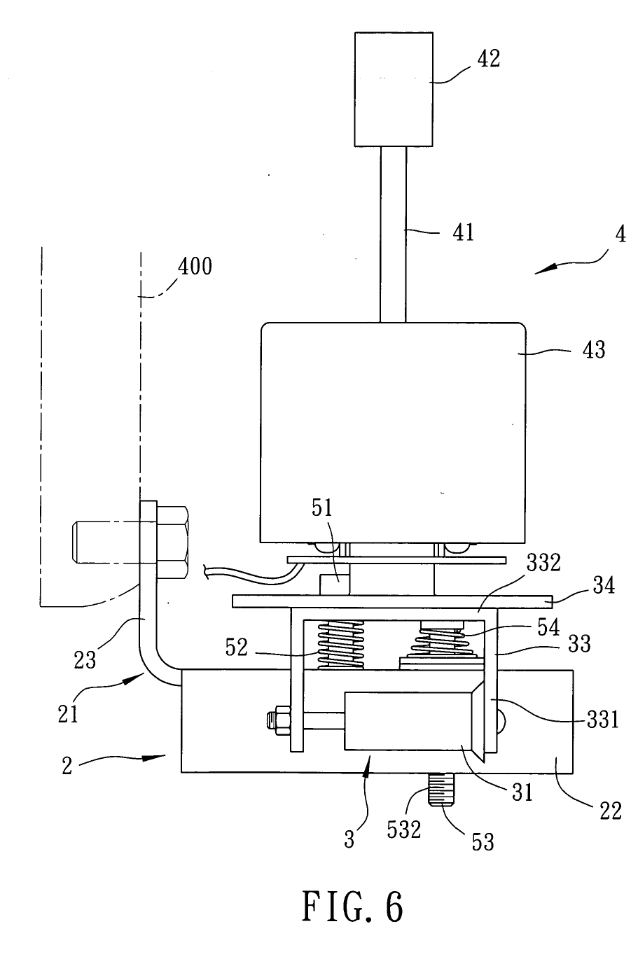

Referring to FIGS. 4, 5, and 6, the preferred embodiment of an electric generator assembly according to the present invention is used on a vehicle having a frame 400 and a rotating element 300. As an example, the vehicle may be a bicycle and the rotating element 300 may be a tire of the bicycle. The electric generator assembly includes a bracket 2 that is adapted to be fixed to the frame 400 of the vehicle, a support 3, an electric generator 4, and an adjusting unit 5. The support 3 is pivotably mounted to the bracket 2. The electric generator 4 is mounted on the support 3,and includes a roller 42 that is adapted to be engaged with the rotating element 300 of the vehicle so as to be driven thereby, a rotating shaft 41 coupled to the roller 42, and a housing 43 into which the rotating shaft 41 extends. The adjusting unit 5 is employed to adjust relative positioning between the bracket 2 and the support 3 to engage the roller 42 with the rotating element 300 and release the roller 42 from the rotating element 300.

The roller 42 is fabricated from an engineering plastic material so as to increase frictional contact between the roller 42 and the rotating element 300.

It should be noted that the design of the bracket 2 may be varied depending on the configuration of the frame 400 and on the particular location of the frame 400 where the bracket 2 is mounted. For instance, the frame 400 may be a fork portion or part of a brake system of a bicycle frame. As another example, the frame 400 may be a seat stay portion of a bicycle frame.

The bracket 2 has an upper surface and a lower surface. The support 3 includes a fixed member 31 mounted fixedly to the bracket 2, a pivoting member 33 having a first end mounted pivotably to the fixed member 31 and a second end opposite to the first end, and a plate member 34 having an upper surface and a lower surface and mounted to the second end of the pivoting member 33.

The electric generator 4 is mounted to the upper surface of the plate member 34 of the bracket 2. The adjusting unit 5 includes first and second fasteners 51, 53. The first fastener 51 has a first head 511 abutting against the upper surface of the plate member 34, a first threaded shaft 512 extending from the first head 511 and through the plate member 34 and the bracket 2, a first nut 56 engaged with the first threaded shaft 512 and abutting against the lower surface of the bracket 2, and a first resilient member 52 sleeved on the first threaded shaft 512 and interposed between the lower surface of the plate member 34 and the upper surface of the bracket 2. The second fastener 53 has a second head 531 abutting against the lower surface of the plate member 34, a second threaded shaft 532 extending from the second head 531 and through the bracket 2, a second nut 57 engaged with the second threaded shaft 532 and associated with the lower surface of the bracket 2, and a second resilient member 54 sleeved on the second threaded shaft 532 and interposed between the second head 531 and the upper surface of the bracket 2. In this embodiment, each of the first and second resilient members 52, 54 is a compression spring.

The adjusting unit 5 further includes a cylindrical washer 55 loosely sleeved on the second threaded shaft 532 and interposed between the lower surface of the bracket 2 and the second nut 57.

In the preferred embodiment, the pivoting member 33 is substantially U-shaped and includes a pair of first arms 331 mounted pivotably to the fixed member 31, and a second arm 332 interconnecting upper ends of the first arms 331. The second arm 332 is formed with a through hole 3321. The second head 531 of the second fastener 53 extends through the through hole 3321 to abut against the lower surface of the plate member 34.

Furthermore, in the preferred embodiment, the bracket 2 includes a connector 23 adapted to be fixed to the frame 400 of the vehicle, a first brace member 21 extending from the connector 23 and having the upper and lower surfaces of the bracket 2, and a second brace member 22 extending from the first brace member 21 at a predetermined angle to the first brace member 21. Preferably, the predetermined angle θ between the first and second brace members 21, 22 is substantially 90 degrees.

In use, when the roller 42 is engaged with the rotating element 300, rotation of the rotating element 300 causes the roller 42 to rotate, which, in turn, results in the rotation of the rotating shaft 41. As a result, electrical energy is generated by the electric generator 4. That is, mechanical rotational energy of the rotating element 300 is converted into electrical energy, which may be subsequently used to power other devices, such as a head lamp (not shown) of the vehicle. Since the operation and construction of the electric generator 4 are well known to those skilled in the art and are not the primary feature of the present invention, a detailed description of the same will be dispensed with herein for the sake of brevity. When the vehicle is traveling on a rugged road or trail surface, the rotating element 300 undergoes vibration. Under the influence of the biasing force of the first resilient member 52, and additionally of the second resilient member 54, the plate member 34 of the support 3 is continuously urged away from the bracket 2 and the vibrational forces are dampened so that the roller 42 can be resiliently retained in contact with the rotating element 300. Additionally, the first nut 56 maybe manipulated to control the biasing force exerted by the first resilient member 52 so that the stiffness with which the roller 42 engages the rotating element 300 can be varied.

When it is desired to disengage the electric generator assembly, the roller 42 of the electric generator 4 can be separated from the rotating element 300 by tightening the second nut 57 so that the second head 531 does not hinder movement of the plate member 34, after which the first nut 56 is tightened so as to move the plate member 34 toward the bracket 2 and thereby disengage the roller 42 from the rotating element 300.

In sum, unlike the conventional electric generator described hereinabove, the present invention incorporates a mounting assembly that allows adjustments in the degree of engagement stiffness of the roller 42 with the rotating element 300. Hence, the roller 42 may be maintained in a state engaged with the rotating element 300 for all road conditions, without creating resistance and without resulting in wear of the rotating element 300.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An electric generator assembly for a vehicle having a frame and a rotating element, said electric generator assembly comprising:
a bracket adapted to be fixed to the frame of the vehicle;
a support pivotably mounted to said bracket;
an electric generator mounted on said support and including a roller adapted to be engaged with the rotating element of the vehicle so as to be driven thereby; and
an adjusting unit for adjusting relative positioning between said bracket and said support to engage said roller with the rotating element and release said roller from the rotating element.

2. The electric generator assembly of claim 1, wherein:
said bracket has an upper surface and a lower surface;
said support includes a fixed member mounted fixedly to said bracket, a pivoting member having a first end mounted pivotably to said fixed member and a second end opposite to said first end, and a plate member having an upper surface and a lower surface and mounted to said second end of said pivoting member;
said electric generator is mounted to said upper surface of said plate member; and
said adjusting unit includes
a first fastener having a first head abutting against said upper surface of said plate member, a first threaded shaft extending from said first head and through said plate member and said bracket, a first nut engaged with said first threaded shaft and abutting against said lower surface of said bracket, and a first resilient member sleeved on said first threaded shaft and interposed between said lower surface of said plate member and said upper surface of said bracket, and
a second fastener having a second head abutting against said lower surface of said plate member, a second threaded shaft extending from said second head and through said bracket, a second nut engaged with said second threaded shaft and associated with said lower surface of said bracket, and a second resilient member sleeved on said second threaded shaft and interposed between said second head and said upper surface of said bracket.

3. The electric generator assembly of claim 2, wherein said adjusting unit further includes a cylindrical washer loosely sleeved on said second threaded shaft and interposed between said lower surface of said bracket and said second nut.

4. The electric generator assembly of claim 2, wherein said pivoting member is substantially U-shaped and includes a pair of first arms mounted pivotably to said fixed member, and a second arm interconnecting upper ends of said first arms, said second arm being formed with a through hole, said second head of said second fastener extending through said through hole to abut against said lower surface of said plate member.

5. The electric generator assembly of claim 2, wherein each of said first and second resilient members is a compression spring.

6. The electric generator assembly of claim 2, wherein said bracket includes a connector adapted to be fixed to the frame of the vehicle, a first brace member extending from said connector and having said upper and lower surfaces of said bracket, and a second brace member extending from said first brace member at a predetermined angle to said first brace member.

7. The electric generator assembly of claim 6, wherein said predetermined angle between said first and second brace members is substantially 90 degrees.
